(19) United States
(12) Patent Application Publication
(10) Pub. No.: US 2017/0187239 A1
(43) Pub. Date: Jun. 29, 2017

(54) WIRELESS POWER FEEDING DEVICE AND WIRELESS POWER FEEDING SYSTEM

(71) Applicant: Shinano Kenshi Co., Ltd., Nagano (JP)

(72) Inventors: Masashi OKUBO, Nagano (JP); Kouichi ICHIKI, Nagano (JP)

(21) Appl. No.: 15/322,645

(22) PCT Filed: Jun. 29, 2015
(86) PCT No.: PCT/JP2015/068731

§ 371 Date: Feb. 13, 2017

(30) Foreign Application Priority Data
Jun. 30, 2014 (JP) 2014-134677
Jun. 29, 2015 (JP) 2015-129740

(51) Int. Cl. H02J 50/10; H02J 50/90

(52) U.S. Cl. CPC H02J 50/10; H02J 50/90

(57) ABSTRACT

Though there have been methods for supplying power to mobile bodies in a wireless manner, it has been difficult to use the methods because of a large power supply efficiency change due to mobile body positions. The present invention reduces power supply efficiency fluctuation with respect to positional changes in a specific space by winding a power feeding coil such that the specific space is included.

### CROSS REFERENCE TO RELATED APPLICATIONS

This is a U.S. national stage of application No. PCT/JP2015/068731, filed on Jun. 29, 2015. Priority under 35 U.S.C. §119(a) and 35 U.S.C. §365(b) is claimed from Japanese Patent Application Nos. 2014-134677, filed on Jun. 30, 2014, and 2015-129740, filed on Jun. 29, 2015, the disclosures of which are also incorporated herein by reference.

### DESCRIPTION

Technical Field

The present invention relates to a wireless power feeding device that feeds power without using a wire, and a wireless power feeding system using the wireless power feeding device.

Background Art

Conventional wireless power feeding technologies using electromagnetic induction action are designed on the assumption that power is fed in a state of a power receiving coil and a power feeding coil being close to and facing each other at a specific distance. In a case of feeding power to a moving body, power is wirelessly fed to the moving body only when the body has moved to a specific position where power feeding is possible (see, for example, JP 2010-063361).

These technologies involve a structure in which a magnetic body such as ferrite is installed on the back surface of a coil and the like to improve power feeding efficiency at a place near the coil so that magnetic fluxes concentrate near the coil (see, for example, JP 11-176677 A).

Although a power feeding coil may move to a position where power feeding is possible in some cases, an object to be fed with power is assumed not to move during power feeding (see, for example, JP 2010-263663 A).

### CITATION LIST

### Patent Literature

### {PTL 1}: JP 2010-063361 A

### {PTL 2}: JP 11-176677 A

### {PTL 3}: JP 2010-263663 A

### SUMMARY OF INVENTION

### Technical Problem

Conventional systems are designed on the assumption that a power feeding coil and a power receiving coil come close to and face each other without taking into account that an object to be fed with power moves. Meanwhile, in order to feed power stably to a moving object, the system needs to be designed such that magnetic flux is distributed uniformly and in a wide range relative to the range where power is fed.

For example, when a small testing device is attached to a small animal and a test is conducted for a long period of time, the animal used for the test moves, and therefore power is preferably fed wirelessly to the testing device. In a case like this, since the testing device with a power receiving coil is moving, wireless power feeding to the testing device needs to be done stably.

In addition, a similar problem occurs in a case where a device with a sensor attached thereto is moving in a space and the sensor is to be fed with power wirelessly.

Note that an amount of energy from power being fed varies greatly even within the possible power feeding range. In a case where a power receiving coil is positioned near a power feeding coil, the power feeding becomes unintendedly excessive and the excessive power needs to be consumed somehow (magnetic flux distribution problem).

An amount of wireless power feeding largely changes depending on the amount of the magnetic flux passing through a power receiving coil. The magnetic flux density obeys the Biot-Savart law to decrease largely when the distance between coils increases. Therefore, when power is fed to a place where the position of a coil is far from a power feeding range, the power needed by the coil increases and, at the same time, a large amount of magnetic flux leaks to the surroundings to generate an induced current in the surrounding metals to cause problems in power loss, overheating of the metals, and the like (magnetic flux leakage problem).

In addition, when a magnetic body exists near a power feeding coil, power feeding cannot be done at a long distance because magnetic fluxes concentrate near the power feeding coil so that it becomes difficult to generate magnetic fluxes for feeding power at a long distance (surrounding magnetic body problem).

### Solution to Problem

Hence, the present invention has been made in order to solve the above problems.

A wireless power feeding device of the present invention is a device for feeding power wirelessly such that a moving body moving in a specific space receives the power, characterized by including a power feeding coil configured to feed power wirelessly, a position of which is adjustable.

Due to this characteristic, the position of the power feeding coil is adjustable in accordance with the moving body.

In addition, in the wireless power feeding device of the present invention, a part or whole of the specific space is included in the power feeding coil.

Due to this characteristic, a part or whole of the specific space is included in the power feeding coil. That is, the space inside the power feeding coil can be the specific space.

In addition, the wireless power feeding device of the present invention includes a power feeding coil position adjustment mechanism for moving the power feeding coil to a position where an existence probability of the moving body is high.

Due to this characteristic, the power feeding coil can be moved to the position where the existence probability of the moving body is the highest in the specific space, and can feed power efficiently.

In addition, a wireless power feeding system of the present invention includes a power feeding position adjustment mechanism for moving the power feeding coil to an appropriate position in order to minimize an influence from the outside on power to be fed.

Due to this characteristic, the power feeding coil can be moved to a position where power feeding efficiency is the highest (i.e. an influence from the outside is minimum) by measuring impedance fluctuation relative to the positional change of the power feeding coil while using the power feeding device.

The wireless power feeding system of the present invention also includes a power feeding position adjustment mechanism for moving the power feeding coil to an appropriate position in order to minimize a fluctuation in an amount of power feeding to the moving body, the fluctuation occurring due to a change in a position of the moving body.

Due to this characteristic, the power feeding coil can be moved to an appropriate position by measuring the fluctuation in an amount of power reception of the moving body relative to the positional change of the moving body while using the power feeding device.

The wireless power feeding system of the present invention includes a power feeding position adjustment mechanism for moving the power feeding coil to an appropriate position depending on a power receiving state of the moving body.

Due to this characteristic, the power feeding coil can be moved to a position where power receiving efficiency is high with respect to the fluctuation in power receiving state caused by any factor of the moving body while using the power feeding device.

### Advantageous Effects of Invention

The present invention can solve the magnetic flux distribution problem, the magnetic flux leakage problem, and the surrounding magnetic body problem. The present invention enables stable wireless power feeding in an energy saving manner over a wide area within a specific region.

Therefore, power can be fed to an object that moves within a certain area, while the object is moving. The present invention can wirelessly feed power to an actuator or a sensor which is conventionally fed with power through a slip ring at a rotation part, in a robot arm and the like. Therefore, the slip ring is no longer needed, and compactification, a longer service life and the like are possible. The present invention can be used in various applications.

### BRIEF DESCRIPTION OF DRAWINGS

FIG. 1 is a perspective view showing the basic concept of the present invention.

FIG. 2 is a graph showing a result of a simulation run on the basis of the concept of the present invention.

FIG. 3 is a diagram showing an example of an actuator moving the position of a power feeding coil.

FIG. 4 is a diagram showing an example of changing the position of the power feeding coil by measuring impedance.

FIG. 5 is a diagram showing an example of changing the position of the power feeding coil by wireless communication from a moving body.

FIG. 6 is a diagram showing an example of feeding power by switching a plurality of power feeding coils.

### DESCRIPTION OF EMBODIMENTS

The present invention will be described below with reference to the drawings. FIG. 1 is a view describing the basic concept of the present invention, and a magnetic field analysis in a case where a moving body that receives power is located within a rectangular section of a power feeding coil 3.

Regarding the magnetic flux density generated when 1 A electric current is flowed into a rectangular coil of 150 mm*300 mm*10 mm and ten turns shown in FIG. 1, a magnetic analysis is conducted by using JMAG Designer of JSOL Corporation.

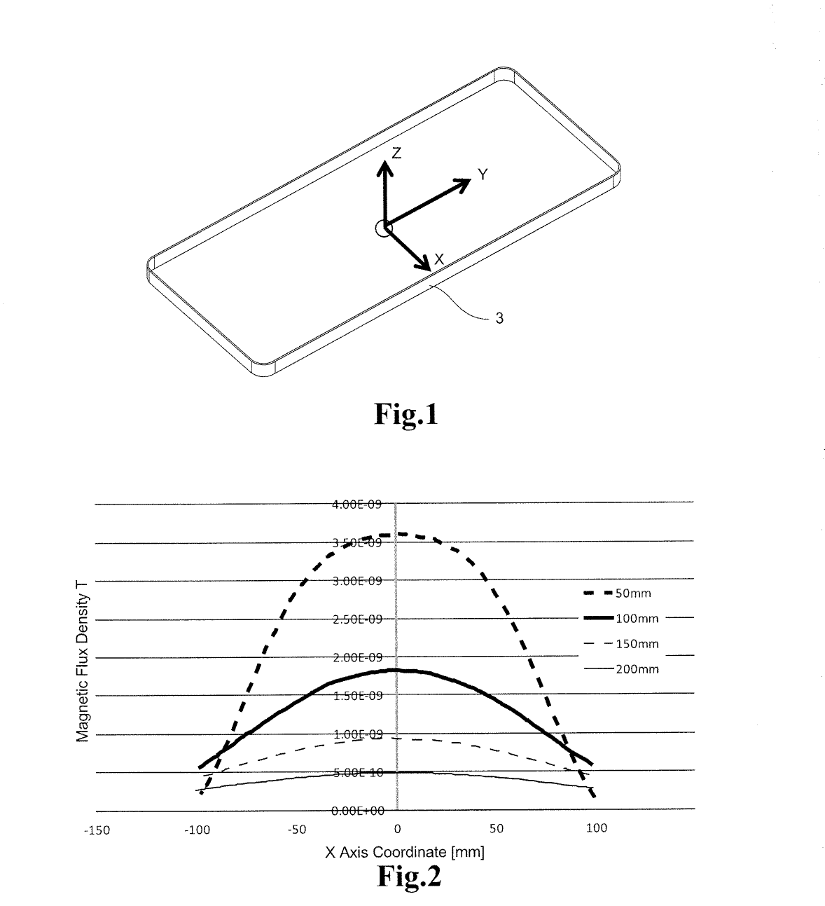

FIG. 2 shows a magnetic flux density distribution in a Z axis direction at each height of the Z axis, at Y=0 with the center of the coil in FIG. 1 set as the origin.

It is found from this that the magnetic flux steeply decreases with an increase in distance from the coil. When power is fed up to an area of 200 mm in height in the Z axis direction, for example, the magnetic flux in the case of Z=200 mm is 1/7 compared to the case of Z=50 mm around the center. It is thus found that the power that can be fed largely varies.

Meanwhile, when power is fed up to the area of 200 mm in height in the Z axis direction similarly, and the coil is placed at 100 mm in height in the Z axis direction, a magnetic flux fluctuates between Z=50 mm and Z=100 mm. Therefore, it is found that the fluctuation of the power that can be fed is ½.

It is found based on these factors that large attenuation as well as steep fluctuation of the power that can be fed can be suppressed by optimizing the position of the coil.

Note that, in FIG. 1, an X axis and a Y axis denote coordinates in the horizontal direction, and the Z axis denotes the height direction (vertical direction). The Z axis has a relative relationship with a position of the coil, and thus the direction of the Z axis does not have to be the vertical direction.

A power feeding efficiency can be increased by determining a position of a power feeding coil (in the Z axis direction) matching the height of a power receiving coil inside a moving body.

Also, as shown in FIG. 2, this characteristic is observed on the inner side of a conductor of the coil, and stable magnetic flux density cannot be expected outside the conductor of the coil (a far side in the circumferential direction). Therefore, it is desirable that a moving body exist inside the coil.

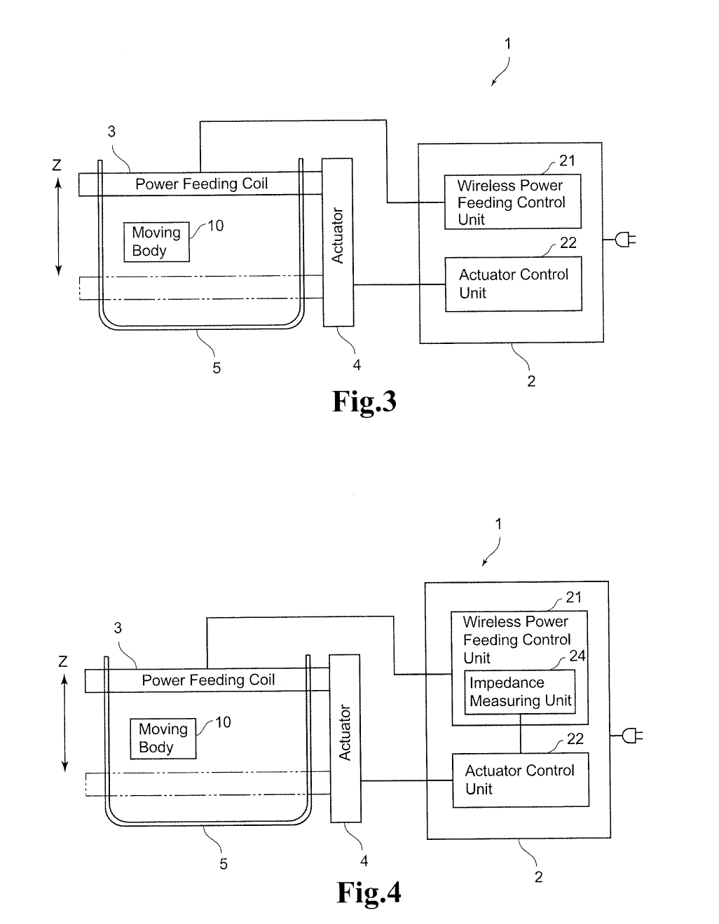

Here, an example is described with reference to FIG. 3. In this example, as a moving body, a testing device with a small animal is set as a power receiving body, a power feeding coil is placed in the horizontal direction as the X and Y axis directions outside a cage (made of a synthetic resin) in which the small animal for test is put, and power is fed with the coil being movable in the Z axis direction (vertical direction).

A wireless power feeding device 1 includes a power feeding device 2 and a power feeding coil 3. The power feeding coil 3 wirelessly feeds power to a moving body 10 serving as the power receiving body. Here, the moving body 10 is placed inside a cage 5 made of a synthetic resin. The power feeding coil 3 for wireless power feeding is wound to orbit horizontally outside the cage 5, and placed to be movable in the Z axis direction with an actuator 4. The power feeding coil 3 is connected to a wireless power feeding control unit 21 and applied with power for feeding having a wireless frequency. The moving body 10 moves in the Z axis direction (vertical direction) as well as on an XY plane in the cage 5.

The power feeding coil 3 can move in the Z axis direction by an actuator control unit 22. A power feeding efficiency is increased by controlling the position of the coil to match a position of the moving body 10 that is the power receiving body.

A wireless power feeding system of the present invention includes such a wireless power feeding device, an actuator that controls the position of a power feeding coil, and a control unit that controls the actuator.

The control unit may measure an impedance of the power feeding coil. An example of this configuration is shown in FIG. 4. An impedance measuring unit 24 measures the impedance of the power feeding coil 3, and grasps an influence of an electromagnetic wave coming from the outside. Thereafter, taking the measurement result into account, the actuator 4 can be controlled such that the position of the power feeding coil 3 moves to a position in the Z axis direction suitable for feeding power to the moving body 10.

As a result, the influence of the electromagnetic field from the outside can be grasped. Therefore, the position of the power feeding coil 3 can be adjusted to make a mutual influence small between power feeding devices when a plurality of power feeding coils 3 exists in the same room or the like.

Note that a control unit on the power feeding side may be notified of a power receiving state of a moving body through wireless communication other than power feeding. An example of this configuration is shown in FIG. 5. The moving body 10 includes a wireless unit 11. The wireless unit 11 notifies a wireless unit 23 in the power feeding device 2 of the power receiving state of the wireless unit 11. The power feeding device 2 can control the height of the power feeding coil 3 in the Z axis direction using the actuator 4 in accordance with the power receiving state which has been notified from the moving body 10.

By notifying the control unit on the power feeding side of the fluctuation in an amount of power reception (=magnetic flux density) when the moving body moves in the horizontal direction (X and Y axis directions), the control unit may search for the height (the Z axis direction) at which the fluctuation in the magnetic flux density is smaller with respect to the movement in the horizontal direction, and move the power feeding coil.

Also, there is a case where an amount of power reception (=magnetic flux density) can fluctuate even when the moving body is not moving. When the moving body itself yaws, pitches, and rolls around the center of gravity thereof, a receiving coil is displaced and thus the amount of power reception fluctuates as a natural consequence. By notifying the power feeding side of the detail of such movement of the moving body and the fluctuation in the amount of power reception in association with each other, the control unit on the power feeding side may search for the height (=the Z axis direction) of the power feeding coil to improve the amount of power reception of the moving body, and move the power feeding coil.

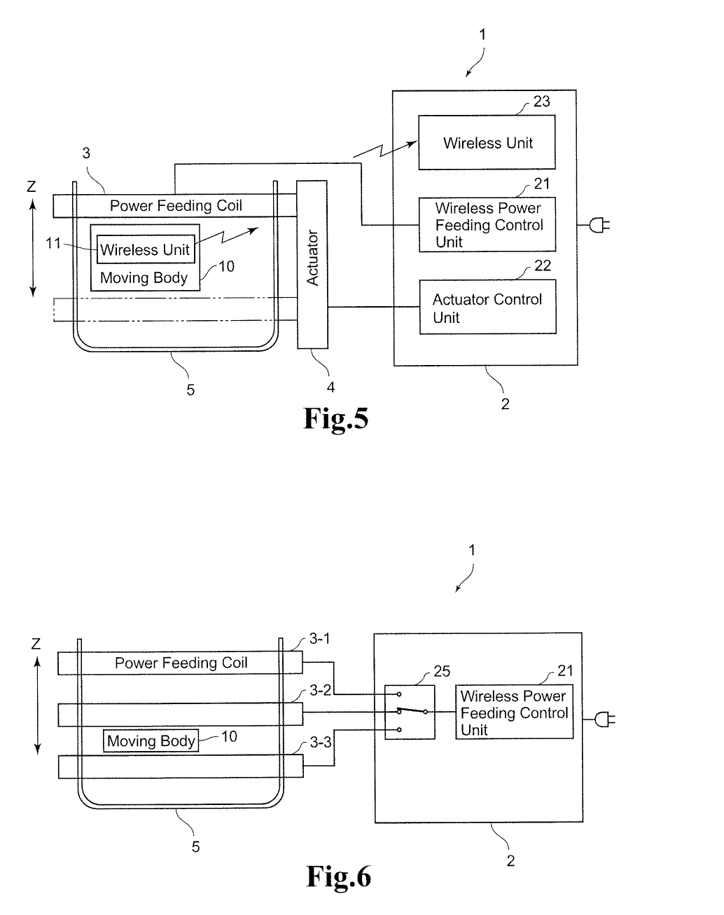

The example mentioned above has been described with an example of moving the position of the power feeding coil 3 by the actuator 4. However, it is also possible to provide a plurality of power feeding coils 3 and switch to any of the power feeding coils 3 which has a good power feeding state, in accordance with a position of the moving body 10. An example thereof is shown in FIG. 6. A plurality of power feeding coils 3-1, 3-2, 3-3, . . . is provided in the Z axis direction, and power feeding to the power feeding coils 3 can be switched with a changeover switch 24. In this case, appropriate power feeding to the moving body 3 is possible without using an actuator. Note that the power feeding coil may be provided slidably to a cage and the like, and may be moved to a position where a power feeding state is good.

When a plurality of moving bodies exists, a power feeding coil is preferably adjusted to a height (a position in the Z axis direction), the value of which most frequently appears among the heights (positions in the Z axis direction) of the power receiving coils of the respective moving bodies.

In a case where a plurality of power feeding coils is placed at adjoining places in large number, the power feeding coils may influence each other. As mentioned above, in a case of using a testing device with a small animal as a moving body, a test is conducted with a large number of cages placed in the same place. In such a case, the position of the power feeding coil can be moved to grasp and eliminate an influence of the electromagnetic field from the outside.

Note that, in the above description, an example of a moving body being a testing device with a small animal as a power receiving body has been described, but the moving body is not limited to the example described above. A toy or a mobile machine tool can be the moving body, for example. Also, the moving body can have a sensor built therein that moves in a certain space.

The present invention has been described above with preferred embodiments; however, the present invention is not limited to these embodiments. Embodiments may include many modifications as long as they do not depart from the spirit of the present invention.

### INDUSTRIAL APPLICABILITY

The present invention can achieve flexible and efficient power feeding to a moving body with a mass-producible wireless power feeding device and a wireless power feeding system using the same. The effects of the present invention include the possibility of novel usage based on convenience and application to other fields.

1. A wireless power feeding device for feeding power wirelessly such that a moving body moving in a specific space receives the power, comprising:
a power feeding coil for feeding power wirelessly, a position of which is adjustable.

2. The wireless power feeding device according to claim 1, wherein a part or whole of the specific space is included in the power feeding coil.

3. The wireless power feeding device according to claim 1, further comprising:
a power feeding coil position adjustment mechanism for moving the power feeding coil to a position where an existence probability of the moving body is high.

4. A wireless power feeding system using the wireless power feeding device according to claim 1, comprising:
a power feeding position adjustment mechanism for moving the power feeding coil to an appropriate position in order to minimize an influence from the outside on power to be fed.

5. A wireless power feeding system using the wireless power feeding device according to claim 1, comprising:
a power feeding position adjustment mechanism for moving the power feeding coil to an appropriate position in order to minimize a fluctuation in an amount of power feeding to the moving body, the fluctuation occurring due to a change in a position of the moving body.

6. A wireless power feeding system using the wireless power feeding device according to claim 1, comprising:
a power feeding position adjustment mechanism for moving the power feeding coil to an appropriate position depending on a power receiving state of the moving body.
